(19) United States
(12) Patent Application Publication
(10) Pub. No.: US 2021/0123498 A1
(43) Pub. Date: Apr. 29, 2021

(54) VISCOUS DAMPER FOR CRANK SHAFT OF VEHICLE

(71) Applicants: HYUNDAI MOTOR COMPANY, Seoul (KR); KIA MOTORS CORPORATION, Seoul (KR)

(72) Inventors: Seongyong KIM, Gunpo-si (KR); Seong Won CHOI, Seoul (KR); Sung Kwang KIM, Seoul (KR)

(73) Assignees: HYUNDAI MOTOR COMPANY, Seoul (KR); KIA MOTORS CORPORATION, Seoul (KR)

(21) Appl. No.: 16/839,848

(22) Filed: Apr. 3, 2020

(30) Foreign Application Priority Data
Oct. 25, 2019 (KR) 10-2019-0133918

(51) Int. Cl. F16F 15/173; F16H 55/36

(52) U.S. Cl. CPC F16F 15/173; F16H 55/36

(57) ABSTRACT

A viscous damper may include: a housing that includes a front surface formed with a hub to fasten a crankshaft at a center of the front surface, a damper groove formed along a circumference of the hub, defining a space divided by a partition wall into a front side space and a rear side space, and a pulley extended rearward from a rear side of the damper groove; a first inertia ring disposed in the rear side space of the damper groove and having a damping function together with a first viscous body; a second inertia ring disposed in the front side space of the damper groove and having a damping function together with a second viscous body; and a cover configured to close a front opening of the front space such that the cover and the damper groove enclose the first and second inertia rings.

### CROSS-REFERENCE TO RELATED APPLICATION

This application claims priority to and the benefit of Korean Patent Application No. 10-2019-0133918, filed on Oct. 25, 2019, the entire contents of which are incorporated herein by reference.

### FIELD

The present disclosure relates to a viscous damper for a crankshaft of a vehicle, and more particularly, to a viscous damper for a crankshaft of a vehicle capable of improving damping performance.

### BACKGROUND

The statements in this section merely provide background information related to the present disclosure and may not constitute prior art.

In general, the crankshaft of the vehicle generates longitudinal vibration, bending vibration, torsional vibration, and the like, when resonating at a specific engine speed, causes a deterioration of ride comfort, and causes parts durability problems.

Among these, since torsional vibration (TV) seriously affects fatigue and breakage of the crankshaft system, rubber dampers for cranks have been used as a final suppressing means.

Although the rubber damper is inexpensive and the characteristic is constant, there is a limit to absorb the vibration energy due to the wide variation in the number of rotation of the engine of the vehicle, and also a disadvantage that cannot avoid the resonance at a specific engine speed.

In order to improve the problems of the rubber damper, a viscous damper filled with high viscosity silicone oil is applied.

The viscous damper refers to a damper that attenuates by using the principle that the shear resistance is generated in the silicone oil due to the relative movement of the damper housing and the inertia ring, and thus the torsional resistance increases.

Therefore, the viscous damper is not subjected to mechanical strain like the rubber damper, so that it can be used in a wide range of use, and has an excellent vibration damping effect even in an engine having many resonance points.

However, we have discovered that the viscous damper according to the prior art has a silicon viscosity change rate of about 200% as the inertia ring temperature changes.

In other words, a problem arises when the temperature is out of the optimum damping setting value of the viscous damper.

Accordingly, the viscous damper according to the prior art cannot provide the optimum damping function at a low temperature or a high temperature, which is disadvantageous to NVH (Noise, Vibration, Harmless) of the vehicle due to high torsional vibration. In addition, the durability of the heat load due to high torsional vibration may occur.

The above information disclosed in this Background section is only for enhancement of understanding of the background of the present disclosure and therefore it may contain information that does not form the prior art that is already known to a person of ordinary skill in the art.

### SUMMARY

The present disclosure provides a viscous damper for a crankshaft of a vehicle that can improve damping performance regardless of the temperature by applying the first viscosity and the second viscous body having a different viscosity.

In some exemplary form of the present disclosure, a viscous damper installed in front of the crankshaft of the vehicle includes: a housing that includes: a front surface formed with a hub configured to fasten the crankshaft at a center of the front surface, a damper groove formed along a circumference of the hub, arranged radially outside of the hub and configured to form a space divided by a partition into a front side space and a rear side space, and a pulley extended rearward from a rear side of the damper groove; a first inertia ring disposed in the rear side space of the damper groove and having a damping function together with a first viscous body filled therein; a second inertia ring disposed in the front side space of the damper groove and having a damping function together with a second viscous body filled therein; and a cover configured to close a front opening of the front space such that the cover and the damper groove enclose the first and second inertia rings.

In some forms of the present disclosure, the first inertia ring may be made of cast iron (Fe) material, and a position of the first inertial ring in the rear side space is positioned or fixed by a first bearing at the center of the rear side space in a front and rear direction. In particular, the first bearing is arranged along an inner circumference of the rear side space.

In some forms of the present disclosure, the first viscous body may be filled in a gap between the first inertial ring and the rear side space to have a thickness in a range of about 0.45 mm to 0.55 mm.

In some forms of the present disclosure, the first viscous body may be a silicon material having a low viscosity in the range of about 900,000 cSt (Centistokes) to 1.1 million cSt.

In some forms of the present disclosure, the second inertia ring may be made of cast iron (Fe) material, and a position of the second inertia ring in the front side space is positioned or fixed by a second bearing at a center of the front side space in the front and rear direction of the front side space, and the second bearing is arranged along an inner circumference of the front side space.

In some forms of the present disclosure, the second viscous body may be filled in a gap between the second inertial ring and the front side space to have a thickness in a range of about 0.65 mm to 0.75 mm.

In some forms of the present disclosure, the second viscous body may be a silicon material having a high viscosity in a range of about 200,000 cSt to 400,000 cSt.

In some forms of the present disclosure, the partition wall may be mounted between the rear side space and the front side space by a force fitting and arranged at a center position in the front and rear direction of the damper groove.

In some forms of the present disclosure, a thickness ration of the first inertia ring to the second inertia ring may be 1.2:1.

In some forms of the present disclosure, the first inertia ring may be formed thicker than the second inertia ring, and the first viscous body filled in the rear side space together with the first inertial ring may have a thinner thickness than a thickness of the second viscous body so as to function to damp at a high temperature ranging from 120° C. to 130° C. In one form, the second inertia ring may be thinner than the first inertia ring, and the second viscous body filled in the front side space together with the second inertia ring may be thicker than the thickness of the first viscous body to function at a low temperature in the range of −30° C. to −20° C.

The viscous damper for a crankshaft of a vehicle according to an exemplary form of the present disclosure divides the damper groove into one side space and the other side space, and then fills the first and second viscosities having different viscosities with different thicknesses. Therefore, the optimum damping performance can be secured regardless of the temperature, and thereby the torsional vibration can be reduced.

Further, the viscous damper for a crankshaft of a vehicle according to an exemplary form of the present disclosure can reduce the heat load by reducing the torsional vibration, thereby reducing the cost by eliminating the heat radiation fins previously applied.

In addition, the effects that can be obtained or predicted by the forms of the present disclosure will be disclosed directly or implicitly in the detailed description of the forms of the present disclosure. That is, various effects predicted according to an form of the present disclosure will be disclosed in the detailed description to be described later.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view illustrating a viscous damper for a crankshaft of a vehicle as assembled;

FIG. 2 is a perspective view of a viscous damper for a crankshaft of a vehicle;

FIG. 3 is a cross-sectional view of a viscous damper for a crankshaft of a vehicle; and.

FIG. 4 is an enlarged view of a portion A of FIG. 3.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure will be described more fully hereinafter with reference to the accompanying drawings, in which exemplary forms of the present disclosure are shown. As those skilled in the art would realize, the described forms may be modified in various different ways, all without departing from the spirit or scope of the present disclosure.

The drawings and description are to be regarded as illustrative in nature and not restrictive. Like reference numerals designate like elements throughout the specification.

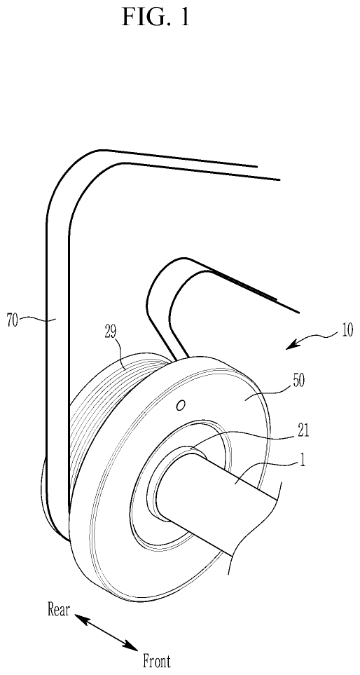

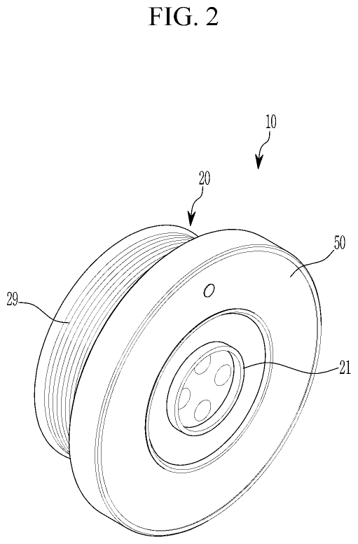

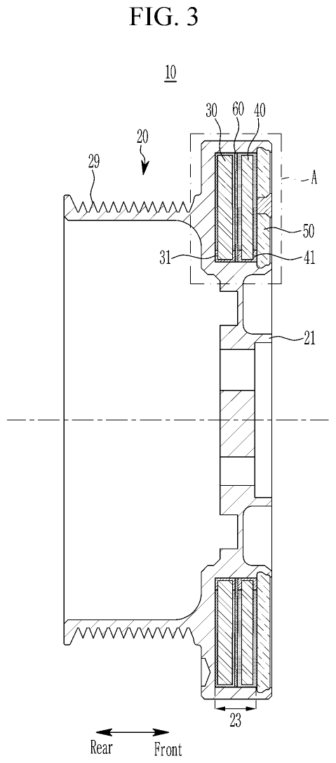

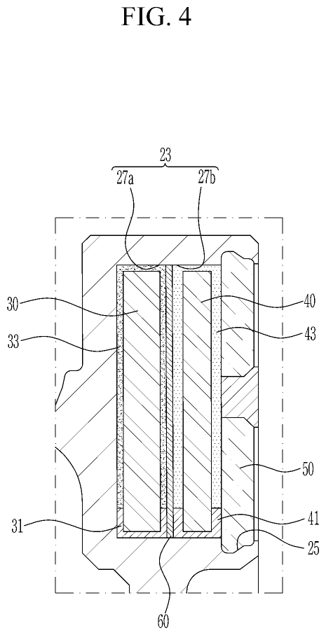

FIG. 1 is a view illustrating a viscous damper for a crankshaft of a vehicle as assembled according to an exemplary form of the present disclosure, FIG. 2 is a perspective view of a viscous damper for a crankshaft of a vehicle according to an exemplary form of the present disclosure, FIG. 3 is a cross-sectional view of a viscous damper for a crankshaft of a vehicle according to an exemplary form of the present disclosure, and FIG. 4 is an enlarged view of a portion “A” of FIG. 3.

Referring to FIGS. 1 and 2, a viscous damper 10 for a crankshaft of a vehicle is installed in front of the crankshaft 1.

In the art, generally, the vehicle body longitudinal direction (assembly conveyance direction) is referred to as the T direction, the vehicle width direction as the L direction, and the height direction of the vehicle body as the H direction.

However, in the exemplary form of the present disclosure, the LTH direction as described above is not set as the reference direction, and the front and rear directions are set as the reference direction based on the drawings (See, FIGS. 1 and 3).

As the definition of the reference direction as described above is a relative meaning, since the direction may vary according to the reference position of the viscous damper 10 or the reference position of the assembled parts, the reference direction is not necessarily limited to the reference direction of the present form.

The viscous damper 10 includes a housing 20, a first inertia ring 30, a second inertia ring 40, and a cover 50.

Torsional vibration generated when the crankshaft 1 rotates is generated, and the torsional vibration is transmitted to and absorbed by the first inertia ring 30 and the second inertia ring 40.

At this time, when the crankshaft 1 rotates by the engine drive, the torsional vibration generates a torsion in the forward or reverse direction of the rotational direction due to the acceleration.

When torsion occurs by the rotation of the crankshaft 1, a restoring force proportional to the torsion angle acts, and the vibration by the restoring force is a torsional vibration.

As described above, the torsional vibration is absorbed by the first inertia ring 30 and the second inertia ring 40.

That is, the viscous damper 10 is due to the relative movement of the housing 10 and the first and second inertia rings 20 and 30, which will be described below, the first viscous body 31 and the second viscous body (Shear resistance is generated in 41), and accordingly, the damping action is performed using the principle that the torsional resistance increases.

On the other hand, the housing 20 has a front surface formed with a hub 21 to which the crankshaft 1 is fastened at a central portion of the front surface.

The front end of the crankshaft 1 is inserted into the hub 21 by a predetermined length, it is made of a structure that is fastened to each other through a bolt.

In addition, the housing 20 has a damper groove 23 formed along the circumference of the hub 21.

The damper groove 23 is arranged radially the outside of the hub 21 formed in the center portion of the front surface.

The damper groove 23 may have a specific setting value as follows.

Referring to FIG. 3, the damper groove 23 may be set in a range of 14 mm to 16 mm in the front and rear direction of the housing 20.

In addition, in front of the damper groove 23, a mounting groove 25 to which the cover 50 will be described, which will be described below, is formed.

The damper groove 23 is partitioned through the partition wall 60 and divided into one side space 27a (e.g., a rear side space) and the front side space 27b (e.g., a front side space). The first inertia ring 30 is installed in the rear side space 27a, and the second inertia ring 40 is installed in the front side space 27b.

At this time, the partition wall 60 is formed in a thin disk shape having a predetermined thickness through the center portion, it may be installed through the interference fit method in the center portion on the basis of the front and rear depth of the damper groove 23.

That is, the damper groove 23 has the rear side space 27a closed through the partition wall 60, and the front side space 27b is closed to the cover 50 fitted into the partition wall 60 and the mounting groove 25. As shown in FIG. 4, the cover 50 is configured to close a front opening of the front space 27b such that the cover and the damper groove enclose the first and second inertia rings 30, 40.

Here, the first inertia ring 30 may be disposed in the rear side space 27a of the damper groove 23, that is, in the rear side space of the damper groove 23.

The first inertia ring 30 may be made of cast iron (Fe) material.

In addition, the first inertia ring 30 is formed in a plate-like ring shape having a predetermined thickness, the thickness may be set in the range of 5 mm or more and 6 mm or less.

The first inertia ring 30 is disposed at the center of the rear side space 27a partitioned by the partition wall 60 based on the depth direction of the damper groove 23. The position of the first inertia ring 30 may be restricted by the first bearing 31 mounted and arranged along the inner circumference of the rear side space 27a. In one form, a position of the first inertial ring 30 in the rear side space 27a is fixed by the first bearing 31 at a center of the rear side space in the front and rear direction.

In addition, a first viscous body 33 is filled in the rear side space 27a.

That is, with the first inertia ring 30 installed in the rear side space 27a, the first viscous body 33 is filled in the remaining space.

At this time, the first viscous body 33 may be filled in a gap between the first inertial ring 30 and the rear side space 27a to have a thickness in the range of 0.45 mm to 0.55 mm.

In addition, the first viscous body 33 is characterized by having a low viscosity in the range of more than 900,000 cSt (Centistokes)˜1.1 million cSt or less.

The cSt (centistokes) is a unit of dynamic viscosity and has a size of one hundredth of one stoke.

The unit of the stokes is cm2/sec, for example, the kinematic viscosity of the room temperature water can be represented by about 1 cst.

The first viscous body 33 may absorb high damping energy at high temperature.

In other words, since the silicone viscosity decreases at high temperatures, the second viscous body 43 having a high viscosity in the rear side space 27a and its thickness are made thin so as to have an optimum damping efficiency in the low temperature region.

The second inertia ring 40 may be disposed in the front side space 27b of the housing 20, that is, the front space of the damper groove 23.

The second inertia ring 40 may be made of cast iron (Fe) material.

In addition, the second inertia ring 40, like the first inertia ring 30, is formed in a plate-like ring shape having a predetermined thickness, the thickness can be set in the range of 4 mm or more to 5 mm or less.

In one form, a thickness ration of the first inertia ring 30 to the second inertia ring 40 is set to be 1.2:1.

The second inertia ring 40 is disposed at the center of the front side space 27b of the damper groove 23 based on the front and rear depths of the damper groove 23. The second inertia ring 40 may be mounted and arranged along the inner circumference of the front side space 27b so that its position may be restricted by the second bearing 41. In one form, a position of the second inertia ring 40 in the front side space 27b is fixed by the second bearing 41 at a center of the front side space 27b in the front and rear direction.

The second bearing 41 may have a thicker side surface than the first bearing 31.

That is, the second bearing 41 is for positioning the second inertia ring 40 thinner than the first inertia ring 30, and the thickness of the side surface of the second bearing 41 is in place. It is desired to form thicker than the first bearing 31.

In addition, a second viscous body 43 is filled in the front side space 27b.

That is, with the second inertia ring 40 installed in the front side space 27b, the second viscous body 43 is filled in the remaining space.

In this case, the second viscous body 43 may be filled in a gap between the second inertial ring 40 and the front side space 27b to have a thickness in the range of 0.65 mm or more to 0.75 mm or less.

In addition, the second viscous body 43 is characterized in that it has a high viscosity in the range of 200,000 cSt or more ˜400,000 cSt or less.

The second viscous body 43 may absorb low damping energy at low temperature.

In other words, since the silicone viscosity increases at low temperature, the second viscous body 43 of low viscosity is filled in the front side space 27b, the thickness of the second viscous body 43 is made thicker than that of the first viscous body 33. Therefore, it is possible to have an optimum damping efficiency in the low temperature region.

The first viscous body 33 and the second viscous body 43 may selectively absorb both high and low temperatures and high damping and low damping energy.

In addition, the first inertia ring is thicker than the second inertia ring, and the first viscous body filled in one side space together with the first inertia ring is made of a thinner structure than the second viscous body. The first inertia ring and the first viscous body have a damping function at a high temperature of about 125° C. On the contrary, the second inertia ring is thinner than the first inertia ring, and the second viscous body filled in the other side space together with the second inertia ring has a structure filled thicker than that of the first viscous body. The two inertia ring and the second viscous body are configured to function as a damping function at a low temperature of about −25° C.

And the pulley 29 to which the drive belt 70 is mounted is integrally formed on the rear side of the housing 20 (see FIG. 1). In one form, the pulley 29 is extended rearward from the rear side of the damper groove.

Accordingly, in the viscous damper 10 for a crankshaft of the vehicle according to the exemplary form of the present disclosure, the first inertia ring 30 and the first viscous body 33 are disposed in rear side space 27a, and the first inertia ring 30 is disposed in the front side space 27b. The two inertia ring 40 and the second viscous body 43 are arranged to improve damping performance regardless of temperature, thereby reducing the torsional vibration.

In addition, the viscous damper 10 for a crankshaft of the vehicle improves the vibration energy by reducing the torsional vibration, and accordingly, the heat load is reduced, thereby eliminating the heat radiation fins previously applied, thereby reducing the cost.

As a result, the viscous damper 10 for the crankshaft of the vehicle is improved in durability, and the drive belt 70 and the NVH (Noise, Vibration, Harmless) of a timing chain (not shown) can be improved.

While this present disclosure has been described in connection with what is presently considered to be practical exemplary forms, it is to be understood that the present disclosure is not limited to the disclosed forms, but, on the contrary, is intended to cover various modifications and equivalent arrangements included within the spirit and scope of the appended claims.

### DESCRIPTION OF SYMBOLS

1: crankshaft 10: viscous damper
20: housing 21: hub
23: damper groove 25: mount groove
27a: rear side space 27b: front side space
29: pulley 30: first inertia ring
31: first bearing 33: first viscous body
40: second inertia ring 41: second bearing
43: second viscous body 50: cover
60: partition wall 70: drive belt

What is claimed is:

1. A viscous damper installed in front of a crankshaft of a vehicle, the viscous damper comprising:
a housing including:
a front surface formed with a hub configured to fasten the crankshaft at a center of the front surface,
a damper groove formed along a circumference of the hub, arranged radially outside of the hub, and configured to form a space divided by a partition wall into a front side space and a rear side space, and
a pulley extended rearward from a rear side of the damper groove;
a first inertia ring disposed in the rear side space of the damper groove and having a damping function together with a first viscous body filled therein;
a second inertia ring disposed in the front side space of the damper groove and having a damping function together with a second viscous body filled therein; and
a cover configured to close a front opening of the front space such that the cover and the damper groove enclose the first and second inertia rings.

2. The viscous damper of claim 1, wherein:
the first inertia ring is made of cast iron (Fe) material,
a position of the first inertial ring in the rear side space is fixed by a first bearing at a center of the rear side space, and
the first bearing is arrange along an inner circumference of the rear side space.

3. The viscous damper of claim 1, wherein:
the first viscous body is filled in a gap between the first inertial ring and the rear side space to have a thickness in a range of about 0.45 mm to 0.55 mm.

4. The viscous damper of claim 1, wherein:
the first viscous body is a silicon material having a low viscosity in a range of about 900,000 cSt (Centistokes) to 1.1 million cSt.

5. The viscous damper of claim 1, wherein:
the second inertia ring is made of cast iron (Fe) material,
a position of the second inertia ring in the front side space is fixed by a second bearing at a center of the front side space, and
the second bearing is arranged along an inner circumference of the front side space.

6. The viscous damper of claim 1, wherein:
the second viscous body is filled in a gap between the second inertial ring and the front side space to have a thickness in a range of about 0.65 mm to 0.75 mm.

7. The viscous damper of claim 1, wherein:
the second viscous body is a silicon material having a high viscosity in a range of about 200,000 cSt to 400,000 cSt.

8. The viscous damper of claim 1, wherein:
the partition wall is mounted between the rear side space and the front side space by a force fitting and arranged at a center position in a front and rear direction of the damper groove.

9. The viscous damper of claim 1, wherein:
a thickness ratio of the first inertia ring to the second inertia ring is 1.2:1.

10. The viscous damper of claim 9, wherein:
the first viscous body filled in the rear side space together with the first inertial ring has a thinner thickness than a thickness of the second viscous body so as to function to damp at a high temperature in a range from about 120° C. to 130° C., and
the second viscous body filled in the front side space together with the second inertia ring is thicker than the thickness of the first viscous body to function at a temperature in a range from about −30° C. to −20° C.
